(19) United States
(12) Patent Application Publication
(10) Pub. No.: US 2022/0363493 A1
(43) Pub. Date: Nov. 17, 2022

(54) SYSTEMS AND METHODS FOR HANDLING PARTICULATE MATERIAL

(71) Applicant: SandSled, LLC, Bossier City, LA (US)

(72) Inventors: Jon BOWLIN, Benton, LA (US); William G. BOWDON, IV, Benton, LA (US)

(21) Appl. No.: 17/321,215

(22) Filed: May 14, 2021

(51) Int. Cl. B65G 65/46; B65G 65/42; B65G 69/04

(52) U.S. Cl. CPC B65G 65/46; B65G 65/42; B65G 69/0433; B65G 65/32

(57) ABSTRACT

A system for handling particulate material includes a vessel and an outflow conveyor. The vessel includes an inlet configured for receipt of particulate material into the vessel, and a plurality of discharge conveyors. Each discharge conveyor is configured to move particulate material in the vessel towards a corresponding discharge valve. The outflow conveyor is configured to receive particulate material from each discharge valve.

### BACKGROUND

### Field

Embodiments of the present disclosure generally relate to systems and methods employed at a work location, such as a well site, for handling particulate material, such as sand.

### Description of the Related Art

Particulate material in various forms is used in many industries, such as mining, construction, food processing and distribution, and ore processing. One particular example is the oil and gas industry, in which particulate material is used in hydraulic fracturing operations in wells. The particulate material, in the form of engineered ceramic particles, sand, or other particles, is pumped as a slurry into a well, and into fractures within the rock into which the well has been drilled. In the oil and gas industry, the particulate material is often referred to as proppant.

As an example, a typical fracturing operation may use as much as about 1,000 to about 2,500 tons of proppant in a day, and about 2,500 to about 20,000 tons of proppant per well. Such quantities present logistical challenges with the delivery and handling of the proppant because a typical truck may carry only about 20 to about 30 tons of proppant. Additionally, the concentration of proppant in the slurry typically is closely controlled in order to optimize the placement of proppant in the fractures. The slurry is created by mixing a feed of proppant with a feed of fracturing fluid in a blender. Using such large quantities of proppant and fluid presents challenges to achieving and sustaining desired concentrations of proppant in the slurry, especially if the feed rate of the proppant to the blender is not maintained at a consistent level.

Thus, there is a need for equipment and methods to alleviate the logistical challenges of handling large quantities of proppant at a well site, and a need for the equipment to provide a consistent rate of feed of the proppant to an end point, such as a blender. The above needs are mirrored in other industries in which large quantities of particulate material are handled at a work location.

### SUMMARY

The present disclosure generally relates to systems and methods employed at a work location, such as a well site, for handling particulate material, such as sand.

In one embodiment, a vessel for handling particulate material includes opposing first and second sides and opposing first and second ends. Each end is coupled to each side. The vessel further includes a base and a trough at the base. The trough includes a floor and first and second sidewalls. The first and second sidewalls extend upwards from the floor at an acute angle to the base. The vessel further includes a conveyor in the trough. The conveyor is configured to move particulate material in the trough towards a discharge point at the first side. The vessel further includes a valve at the discharge point.

In another embodiment, a system for handling particulate material includes a vessel and an outflow conveyor. The vessel includes an inlet configured for receipt of particulate material into the vessel, and a plurality of discharge conveyors. Each discharge conveyor is configured to move particulate material in the vessel towards a corresponding discharge valve. The outflow conveyor is configured to receive particulate material from each discharge valve.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only exemplary embodiments and are therefore not to be considered limiting of its scope, as the disclosure may admit to other equally effective embodiments.

FIGS. 1A-1C provide a schematic process flow diagram for the handling of a particulate material.

FIGS. 2A-2C are top, end, and side views, respectively, of an example component that is used in the process shown in FIGS. 1A-1C.

FIGS. 3A-3D provide top, end, and side views of a system arranged to handle particulate material according to the process shown in FIGS. 1A-1C.

To facilitate understanding, identical reference numerals have been used, where possible, to designate identical elements that are common to the figures. It is contemplated that elements and features of one embodiment may be beneficially incorporated in other embodiments without further recitation.

### DETAILED DESCRIPTION

The present disclosure concerns systems and methods for handling particulate material. The particulate material can be any material existing as discrete elements, such as sand; gravel; coal; ore; pulverized scrap materials; wood chips; agricultural products, such as fruits, vegetables, grains, or legumes; and the like. The systems and methods of the present disclosure can be used to handle particulate material including relatively small discrete elements, such as sand grains, wheat grains, or the like. The systems and methods of the present disclosure can be used to handle particulate material including relatively large discrete elements, such as rubble; food produce, such as potatoes; or the like. The systems and methods of the present disclosure can be used to handle dry particulate material (such as including less than about 2% free water by weight), damp particulate material (such as including about 2% to about 6% free water by weight), or wet particulate material (such as including more than about 6% free water by weight). The systems and methods of the present disclosure can be used in various industries, such as mining; construction; waste processing and recycling; food processing and distribution; minerals extraction and processing; and oil and gas.

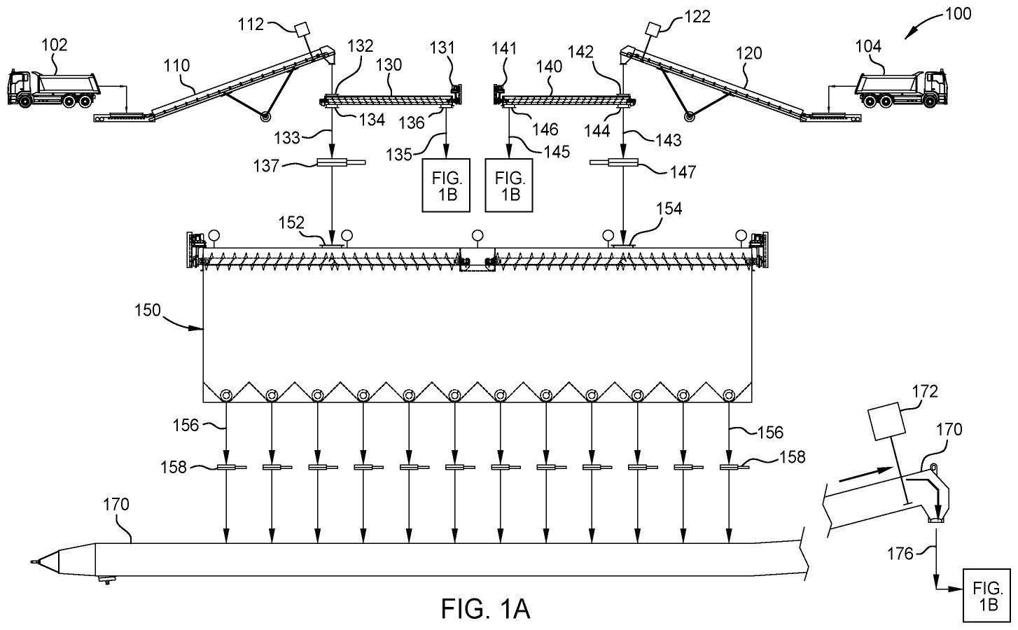

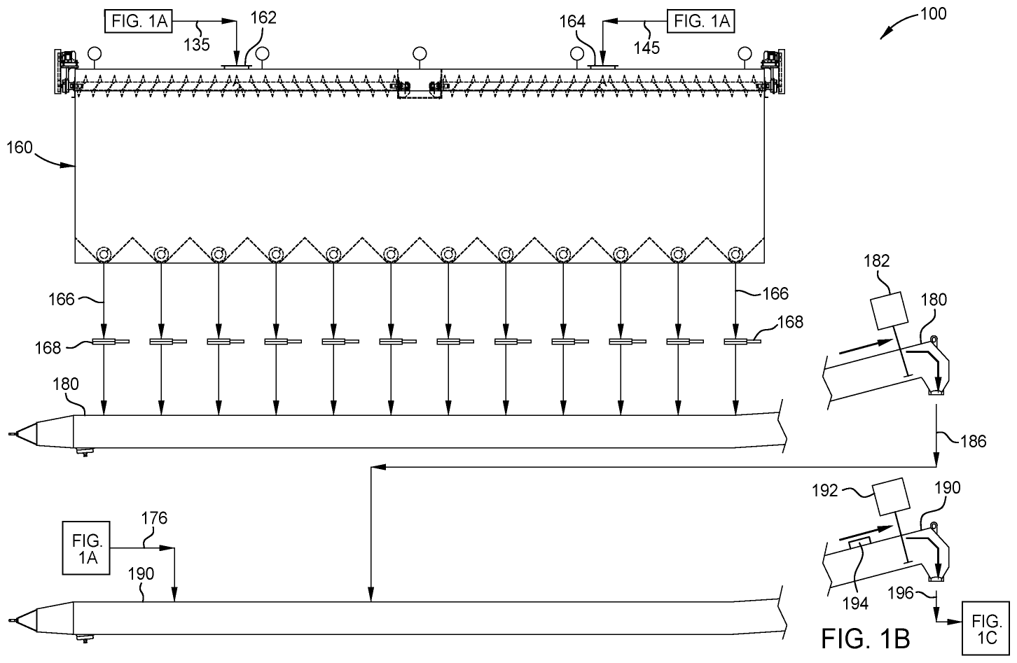

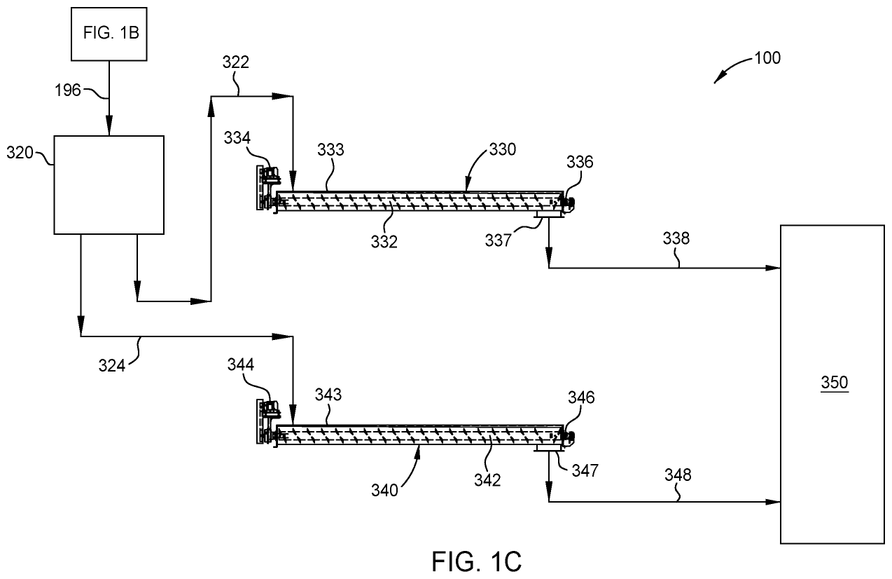

FIGS. 1A-1C provide a schematic process flow diagram for the handling of a particulate material, such as sand or any other particulate material, as discussed above. Arrows in FIGS. 1A-1C indicate the passage of the particulate material from upstream to downstream stages.

In a process 100, particulate material is unloaded from truck 102 onto a first feed conveyor 110. The first feed conveyor 110 may be any suitable type of conveyor, such as a belt conveyor, pocket belt conveyor, bucket elevator, screw conveyor, pneumatic conveyor, or a tubular drag disc conveyor. In some embodiments which may be combined with other embodiments, it is contemplated that the first feed conveyor 110 includes a scale 112 that provides measurements of the weight of particulate material being carried by the first feed conveyor 110. The scale 112 may provide a continuous measurement of weight or a measurement of weight at intervals of time, such as every second. Additionally, or alternatively, the first feed conveyor 110 may include a sensor for monitoring the rate of operation of the first feed conveyor 110. The sensor may provide signals that can be correlated to an incremental volume and/or weight of particulate material being delivered by the first feed conveyor 110.

The first feed conveyor 110 discharges the particulate material into an inlet 132 of a first transfer conveyor 130. The first transfer conveyor 130 may be any suitable type of conveyor, such as a belt conveyor, pocket belt conveyor, screw conveyor, pneumatic conveyor, or a tubular drag disc conveyor. In some embodiments which may be combined with other embodiments, it is contemplated that the first transfer conveyor 130 may include a sensor for monitoring the rate of operation of the first transfer conveyor 130. The sensor may provide signals that can be correlated to an incremental volume and/or weight of particulate material being delivered by the first transfer conveyor 130. As illustrated, the first transfer conveyor 130 is powered by a motor 131. A first exit stream 133 of the particulate material from a first outlet 134 of the first transfer conveyor 130 passes through a valve 137, such as a gate valve, to a first inlet 152 of a first vessel 150. A second exit stream 135 of the particulate material from a second outlet 136 of the first transfer conveyor 130 passes to a first inlet 162 of a second vessel 160. The first 150 and second 160 vessels provide a buffer volume of the particulate material being handled.

In some embodiments which may be combined with other embodiments, it is contemplated that operation of the valve 137 and/or the first transfer conveyor 130 may be regulated in order to adjust the quantities of particulate material in the first 133 and second 135 exit streams. In one example, if the valve 137 is fully open, or substantially fully open, and the first transfer conveyor 130 is not being operated, as much as about 90 to 100 percent of the particulate material discharged into the inlet 132 may pass in the first exit stream 143 to the first inlet 152 of the first vessel 150. In such a scenario, from 0 to about 10 percent of the particulate material discharged into the inlet 132 may pass in the second exit stream 135 to the first inlet 162 of the second vessel 160.

In another example, if the valve 137 is partially open and/or the first transfer conveyor 130 is being operated, from about 10 to about 90 percent of the particulate material discharged into the inlet 132 may pass in the first exit stream 133 to the first inlet 152 of the first vessel 150, and about 10 to about 90 percent of the particulate material discharged into the inlet 132 may pass in the second exit stream 135 to the first inlet 162 of the second vessel 160. In a further example, if the valve 137 is closed, or substantially closed, and the first transfer conveyor 130 is being operated, as much as about 90 to 100 percent of the particulate material discharged into the inlet 132 may pass in the second exit stream 135 to the first inlet 162 of the second vessel 160. In such a scenario, from 0 to about 10 percent of the particulate material discharged into the inlet 132 may pass in the first exit stream 133 to the first inlet 152 of the first vessel 150.

Particulate material is unloaded from truck 104 onto a second feed conveyor 120. The second feed conveyor 120 may be any suitable type of conveyor, such as a belt conveyor, pocket belt conveyor, bucket elevator, screw conveyor, pneumatic conveyor, or a tubular drag disc conveyor. In some embodiments which may be combined with other embodiments, it is contemplated that the second feed conveyor 120 includes a scale 122 that provides measurements of the weight of particulate material being carried by the second feed conveyor 120. The scale 122 may provide a continuous measurement of weight or a measurement of weight at intervals of time, such as every second. Additionally, or alternatively, the second feed conveyor 120 may include a sensor for monitoring the rate of operation of the second feed conveyor 120. The sensor may provide signals that can be correlated to an incremental volume and/or weight of particulate material being delivered by the second feed conveyor 120.

The second feed conveyor 120 discharges the particulate material in to an inlet 142 of a second transfer conveyor 140. The second transfer conveyor 140 may be any suitable type of conveyor, such as a belt conveyor, pocket belt conveyor, screw conveyor, pneumatic conveyor, or a tubular drag disc conveyor. In some embodiments which may be combined with other embodiments, it is contemplated that the second transfer conveyor 140 may include a sensor for monitoring the rate of operation of the second transfer conveyor 140. The sensor may provide signals that can be correlated to an incremental volume and/or weight of particulate material being delivered by the second transfer conveyor 140. As illustrated, the second transfer conveyor 140 is powered by a motor 141. A first exit stream 143 of the particulate material from a first outlet 144 of the second transfer conveyor 140 passes through a valve 147, such as a gate valve, to a second inlet 154 of the first vessel 150. A second exit stream 145 of the particulate material from a second outlet 146 of the second transfer conveyor 140 passes to a second inlet 164 of the second vessel 160.

In some embodiments which may be combined with other embodiments, it is contemplated that operation of the valve 147 and/or the second transfer conveyor 140 may be regulated in order to adjust the quantities of particulate material in the first 143 and second 145 exit streams. In one example, if the valve 147 is fully open, or substantially fully open, and the second transfer conveyor 140 is not being operated, as much as about 90 to 100 percent of the particulate material discharged into the inlet 142 may pass in the first exit stream 143 to the second inlet 154 of the first vessel 150. In such a scenario, from 0 to about 10 percent of the particulate material discharged into the inlet 142 may pass in the second exit stream 145 to the second inlet 164 of the second vessel 160.

In another example, if the valve 147 is partially open and/or the second transfer conveyor 140 is being operated, from about 10 to about 90 percent of the particulate material discharged into the inlet 142 may pass in the first exit stream 143 to the second inlet 154 of the first vessel 150, and about 10 to about 90 percent of the particulate material discharged into the inlet 142 may pass in the second exit stream 145 to the second inlet 164 of the second vessel 160. In a further example, if the valve 147 is closed, or substantially closed, and the second transfer conveyor 140 is being operated, as much as about 90 to 100 percent of the particulate material discharged into the inlet 142 may pass in the second exit stream 145 to the second inlet 164 of the second vessel 160. In such a scenario, from 0 to about 10 percent of the particulate material discharged into the inlet 142 may pass in the first exit stream 143 to the second inlet 154 of the first vessel 150.

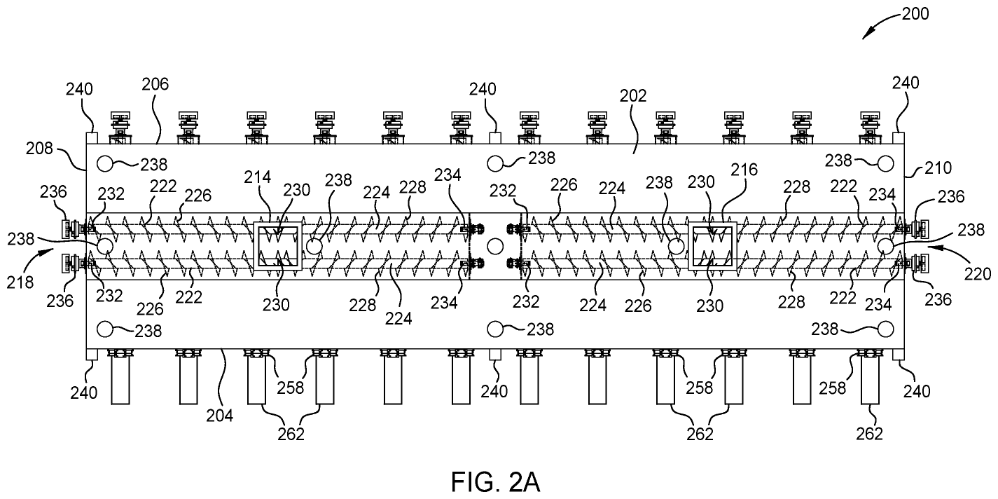

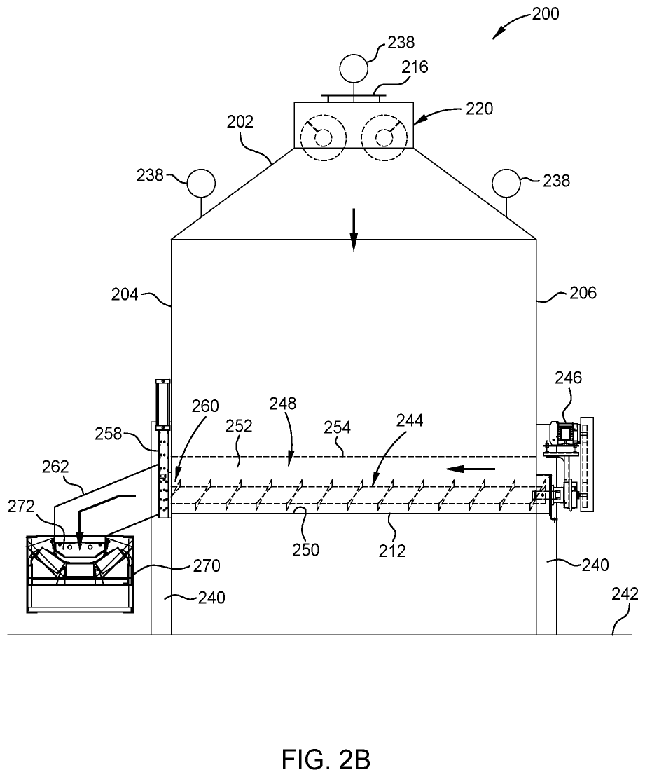

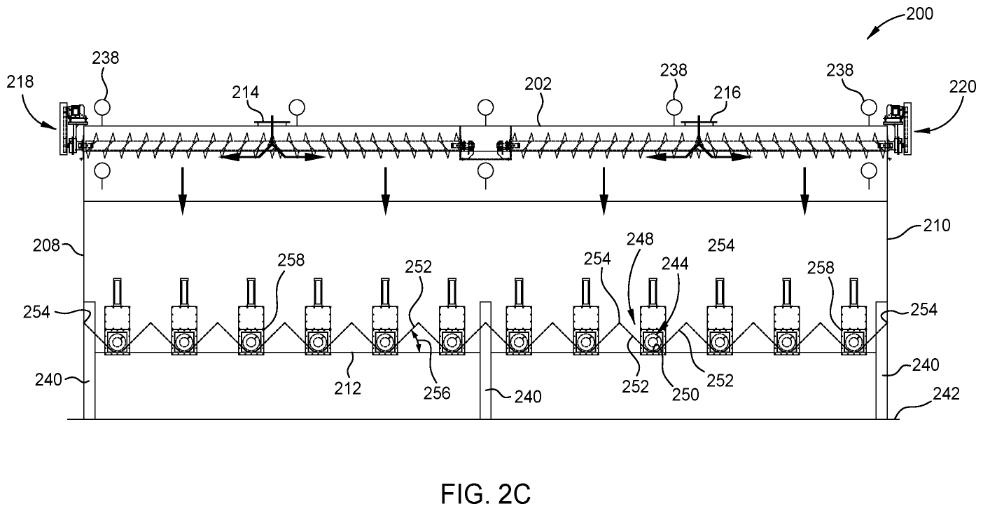

The first vessel 150 includes a container, such as a box, a hopper, a silo, or the like, that is sized to accommodate a plurality of loads of particulate material from individual trucks, such as trucks 102, 104. Details of the structure and operation of the first vessel 150 are discussed below with respect to FIGS. 2A-2C. The particulate material is discharged from the first vessel 150 to a first outflow conveyor 170 in one or more exit streams 156. Each exit stream 156 passes through a discharge valve 158, such as a gate valve. The first outflow conveyor 170 may be any suitable type of conveyor, such as a belt conveyor, pocket belt conveyor, bucket elevator, screw conveyor, pneumatic conveyor, or a tubular drag disc conveyor. In some embodiments which may be combined with other embodiments, it is contemplated that the first outflow conveyor 170 includes a scale 172 that provides measurements of the weight of particulate material being carried by the first outflow conveyor 170. The scale 172 may provide a continuous measurement of weight or a measurement of weight at intervals of time, such as every second. Additionally, or alternatively, the first outflow conveyor 170 may include a sensor for monitoring the rate of operation of the first outflow conveyor 170. The sensor may provide signals that can be correlated to an incremental volume and/or weight of particulate material being delivered by the first outflow conveyor 170.

The second vessel 160 includes a container, such as a box, a hopper, a silo, or the like, that is sized to accommodate a plurality of loads of particulate material from individual trucks, such as trucks 102, 104. Details of the structure and operation of the second vessel 160 are discussed below with respect to FIGS. 2A-2C. The particulate material is discharged from the second vessel 160 to a second outflow conveyor 180 in one or more exit streams 166. Each exit stream 166 passes through a discharge valve 168, such as a gate valve. The second outflow conveyor 180 may be any suitable type of conveyor, such as a belt conveyor, pocket belt conveyor, bucket elevator, screw conveyor, pneumatic conveyor, or a tubular drag disc conveyor. In some embodiments which may be combined with other embodiments, it is contemplated that the second outflow conveyor 180 includes a scale 182 that provides measurements of the weight of particulate material being carried by the second outflow conveyor 180. The scale 182 may provide a continuous measurement of weight or a measurement of weight at intervals of time, such as every second. Additionally, or alternatively, the second outflow conveyor 180 may include a sensor for monitoring the rate of operation of the second outflow conveyor 180. The sensor may provide signals that can be correlated to an incremental volume and/or weight of particulate material being delivered by the second outflow conveyor 180.

A transport conveyor 190 receives a discharge 176 from the first outflow conveyor 170 and a discharge 186 from the second outflow conveyor 180. The transport conveyor 190 may be any suitable type of conveyor, such as a belt conveyor, pocket belt conveyor, bucket elevator, screw conveyor, pneumatic conveyor, or a tubular drag disc conveyor. In some embodiments which may be combined with other embodiments, it is contemplated that the transport conveyor 190 includes a scale 192 that provides measurements of the weight of particulate material being carried by the transport conveyor 190. The scale 192 may provide a continuous measurement of weight or a measurement of weight at intervals of time, such as every second. Additionally, it is contemplated that the transport conveyor may include a meter 194 that provides measurements of the moisture content of particulate material being carried by the transport conveyor 190. The meter 194 may provide a continuous measurement of moisture content or a measurement of moisture content at intervals of time, such as every second. Additionally, or alternatively, the transport conveyor 190 may include a sensor for monitoring the rate of operation of the transport conveyor 190. The sensor may provide signals that can be correlated to an incremental volume and/or weight of particulate material being delivered by the transport conveyor 190.

In some embodiments which may be combined with other embodiments, it is contemplated that the process 100 may include delivering a discharge 196 of particulate material from the transport conveyor 190 to additional equipment, such as illustrated in FIG. 1C. In FIG. 1C, the discharge 196 of particulate material enters a hopper 320. A first feed 322 from the hopper 320 is taken by a first infeed conveyor 330, and is fed into a blender 350. The first infeed conveyor 330 includes a casing 333 housing a screw 332 that is rotated by a motor 334. A sensor 336, such as an encoder, provides signals representative of full and/or partial rotations of the screw 332; each full or partial rotation may be correlated to an incremental volume and/or weight of particulate material being delivered in a discharge 338 from an outlet 337 of the first infeed conveyor 330 to the blender 350. A second feed 324 from the hopper 320 is taken by a second infeed conveyor 340, and is fed into the blender 350. The second infeed conveyor 340 includes a casing 343 housing a screw 342 that is rotated by a motor 344. A sensor 346, such as an encoder, provides signals representative of full and/or partial rotations of the screw 342; each full or partial rotation may be correlated to an incremental volume and/or weight of particulate material being delivered in a discharge 348 from an outlet 347 of the second infeed conveyor 340 to the blender 350.

Although two infeed conveyors 330, 340 are illustrated, it is contemplated that any suitable number of infeed conveyors 330/340 may be used, such as one, two, three, four, or more. In some embodiments which may be combined with other embodiments, it is contemplated that the infeed conveyors 330, 340 may be omitted. In some embodiments which may be combined with other embodiments, it is contemplated that the hopper 320, the infeed conveyors 330, 340, and the blender 350 may be omitted, and the discharge 196 of particulate material from the transport conveyor 190 may be delivered to other equipment.

In some embodiments which may be combined with other embodiments, it is contemplated that the process 100 may include provision for unloading only a single truck 102/104. In such a scenario, one of the first 110 and second 120 feed conveyors, and one of the first 130 and second 140 transfer conveyors, may be omitted. In some embodiments which may be combined with other embodiments, it is contemplated that the process 100 may include provision for unloading more than two trucks 102, 104 simultaneously. In such a scenario, the process 100 may include one or more additional feed conveyors. Additionally, the process 100 may include one or more additional transfer conveyors.

In some embodiments which may be combined with other embodiments, it is contemplated that the process 100 may include only a single vessel 150/160. In such a scenario, one of the first 150 and second 160 vessels, one of the first 130 and second 140 transfer conveyors, and one of the first 170 and second 180 outflow conveyors may be omitted. In one example, both the first 170 and second 180 outflow conveyors are omitted, and the single vessel 150/160 discharges particulate material directly to the transport conveyor 190. In some embodiments which may be combined with other embodiments, it is contemplated that the process 100 may include more than two vessels. In such a scenario, the process 100 may include more than two outflow conveyors. In one example, the process 100 includes one or more additional transport conveyor 190 for receiving the particulate material from the additional outflow conveyor(s).

FIGS. 2A-2C are top, end, and side views, respectively, of an example vessel 200. The vessel 200 provides a buffer volume of the particulate material being handled. Either or both the first vessel 150 and the second vessel 160 may be configured in a same or similar way as the vessel 200. Arrows in FIGS. 2B and 2C indicate the passage of the particulate material from upstream to downstream stages.

The vessel 200 can be used to handle dry particulate material (such as including less than about 2% free water by weight), damp particulate material (such as including about 2% to about 6% free water by weight), or wet particulate material (such as including more than about 6% free water by weight). The vessel 200 is suitable for the handling a variety of particulate materials, as discussed above, and can be used in various industries, such as mining; construction; waste processing and recycling; food processing and distribution; minerals extraction and processing; and oil and gas.

The vessel 200 is sized to accommodate a plurality of loads of particulate material from individual trucks, such as trucks 102, 104. In an example, a truck, such as truck 102, carries from about 25 tons to about 30 tons of damp particulate material, and the vessel accommodates from about 300 tons to about 500 tons, such as from about 350 tons to about 450 tons, such as about 400 tons, of damp particulate material. The accommodation of particulate material in the vessel facilitates the maintenance of a controlled and consistent feed of particulate material to downstream equipment even if there are fluctuations in the rates of delivery and unloading of particulate material upstream of the vessel 200.

The vessel 200 is an enclosed container including opposing first 204 and second 206 sides; two opposing ends 208, 210 coupled to each side 204, 206; a roof 202 coupled to each side 204, 206 and each end 208, 210; and a base 212 coupled to each side 204, 206 and each end 208, 210. The roof 202 includes a first inlet 214 and a second inlet 216, through which particulate material enters the vessel 200. In some embodiments which may be combined with other embodiments, it is contemplated that the roof 202 may include only a single inlet 214/216, such that one of the first 214 and second 216 inlets is omitted. Alternatively, the roof 202 may include more than two inlets.

In some embodiments which may be combined with other embodiments, it is contemplated that an exterior surface of the vessel 200 may be coated with a heat-absorbing material, such as a paint. In an example, the heat-absorbing material promotes heating of the vessel 200 sides 204, 206 and ends 208, 210 by sunlight in order to mitigate a propensity of particulate material to stick to the sides 204, 206 and ends 208, 210 of the vessel 200. In some embodiments which may be combined with other embodiments, it is contemplated that an interior surface of the vessel 200 may be coated with a material that resists adherence of particulate materials.

As best shown in FIG. 2A, a first leveling mechanism 218 is associated with the first inlet 214, and a second leveling mechanism 220 is associated with the second inlet 216. Each leveling mechanism 218, 220 incudes a pair of leveling screws 222, each leveling screw 222 powered by a corresponding motor 236. Each leveling screw 222 includes a shaft 224, a right-hand helical vane 226, and a left-hand helical vane 228. Each right-hand helical vane 226 begins at a location 230 on the respective shaft 224 corresponding to a juxtaposition of the leveling screw 222 with the respective first 214 or second 216 inlet, and extends along the shaft 224 towards a first end 232 of the shaft 224. Each left-hand helical vane 228 begins at the location 230 on the shaft 224 corresponding to the juxtaposition of the leveling screw 222 with the respective first 214 or second 216 inlet, and extends along the shaft 224 towards a second end 234 of the shaft 224 opposite to the first end 232.

Particulate material delivered through one of the first 214 and second 216 inlets tends to settle on the base 212 into a cone-shaped pile having an apex centered below the respective inlet 214/216. With successive deliveries of particulate material, the cone-shaped pile grows, and the apex may reach the respective leveling mechanism 218/220, whereas other portions of the vessel 200, such as zones between each inlet 214/216 and the ends 208/210, remain relatively devoid of particulate material. Operation of the corresponding leveling mechanism 218, 220 distributes the particulate material at the cone apex towards each end 208, 210 of the vessel 200 to provide an efficient use of the space inside the vessel 200.

In some embodiments which may be combined with other embodiments, it is contemplated that each leveling mechanism 218, 220 may include only a single leveling screw 222. Alternatively, it is contemplated that each leveling mechanism 218, 220 may include more than two leveling screws 222. In some embodiments which may be combined with other embodiments, it is contemplated that each leveling mechanism 218, 220 may include one or more leveling conveyors, such as a belt conveyor, pneumatic conveyor, or a tubular drag disc conveyor instead of one or more leveling screws 222.

In some embodiments which may be combined with other embodiments, it is contemplated that each leveling mechanism 218, 220 may include one or more baffle plate below at least a portion of each leveling screw 222 (or each leveling conveyor) in order to promote the movement of particulate material towards each end 208, 210, and/or each side 204, 206, of the vessel 200. Additionally, or alternatively, each leveling mechanism 218, 220 may include one or more baffle plate below at least a portion of each inlet 214, 216. In an example, each leveling mechanism 218, 220 includes one or more baffle plate below at least a portion of each inlet 214, 216, and the leveling screws 222 (or leveling conveyors) are omitted.

A level indicator 238, such as an ultrasonic sonde, provides a measurement of the level of particulate material at a zone within the vessel 200. As illustrated, it is contemplated that a plurality of level indicators 238, each positioned at a different location, may be utilized to provide measurements of the level(s) of particulate material at different zones within the vessel 200. Measurements from the level indicators 238 may provide inputs for the control of the particulate material handling operation, as described further below. Additionally, or alternatively, it is contemplated that one or more cameras may be located within the vessel 200 to provide an operator with a visual display of the distribution of particulate material within the vessel 200. In an example, when the vessel 200 is handling damp particulate material and dust is not prevalent, the vision provided by a camera may be relatively unobscured.

The vessel 200 includes legs 240. As shown in FIGS. 2B-2C, the legs 240 stand on the ground surface 242, and maintain the base 212 of the vessel 200 in a position raised above the ground surface 242. In some embodiments which may be combined with other embodiments, it is contemplated that a length and/or a position of each leg 240 may not be adjustable. In some embodiments which may be combined with other embodiments, it is contemplated that a length and/or a position of each leg 240 may be adjustable, such as manually, mechanically, electrically, pneumatically, or hydraulically. In an example, the adjustable length and/or position of each leg 240 enables the base 212 to be positioned at a desired elevation above the ground surface 242. In another example, the adjustable length and/or position of each leg 240 enables the base 212 to be positioned at a desired orientation with respect to a horizontal plane, such as parallel to, or within about five degrees of, or within about ten degrees of, or within about twenty degrees of, a horizontal plane. In a further example, the adjustable length and/or position of each leg 240 enables the base 212 to be positioned at a desired orientation with respect to a horizontal plane even if the ground surface 242 is uneven or is inclined at a different orientation to the desired orientation.

It is further contemplated that each leg 240 may include a sensor that provides a signal representative of the weight being borne the corresponding leg 240. The signals from the sensor of each leg 240 may facilitate an estimation of the weight and/or distribution of the particulate material within the vessel 200.

In some embodiments which may be combined with other embodiments, it is contemplated that each leg 240 may be formed as part of the vessel 200. Additionally, or alternatively, each leg 240 may be attached to the vessel 200. Additionally, or alternatively, each leg 240 may be attached to a frame, and the frame may carry the vessel 200. In some embodiments which may be combined with other embodiments, it is contemplated that the vessel 200 may be brought to a work site on a wheeled trailer, and the legs 240 may be actuated to lift the vessel 200 off the trailer. Alternatively, the vessel 200 may be brought to a work site on a wheeled trailer, and the legs 240 may be actuated to lift the wheels of the trailer off the ground surface 242. Alternatively, the vessel 200 may be brought to a work site on a wheeled trailer, and the legs 240 may be actuated so that the weight of the vessel 200 and contents are supported on the ground surface 242 by the legs 240 and by the wheels of the trailer.

As shown in FIGS. 2B-2C, the vessel 200 includes one or more discharge conveyors 244. Each discharge conveyor 244 may be any suitable type of conveyor, such as a belt conveyor, pocket belt conveyor, screw conveyor, pneumatic conveyor, or a tubular drag disc conveyor. In some embodiments which may be combined with other embodiments, it is contemplated that each discharge conveyor 244 may include a sensor for monitoring the rate of operation of each discharge conveyor 244. The sensor may provide signals that can be correlated to an incremental volume and/or weight of particulate material being delivered by each discharge conveyor 244. Each discharge conveyor 244 is powered by a motor 246. Although twelve discharge conveyors 244 are illustrated in the figures, it is contemplated that the vessel 200 may include any suitable number of discharge conveyors 244. For example, the number of discharge conveyors 244 may be selected according to the size of the vessel 200, the type of particulate material to be handled in the vessel 200, the quantity of particulate material to be handled in the vessel 200, the throughput capacity of the discharge conveyors 244, the desired rate of discharge from the vessel 200, the desired level of sparing or redundancy of components such as discharge conveyors 244, the capital and operating costs involved, and the like.

Each discharge conveyor 244 is located in a corresponding trough 248 at the base 212 of the vessel 200. Each trough 248 includes a floor 250 and sidewalls 252 extending upwards from the floor 250 to corresponding crests 254 that also extend laterally within the vessel 200 from the first side 204 to the second side 206 of the vessel 200. Each discharge conveyor 244 is positioned in a corresponding trough 248 such that each discharge conveyor 244 is below a vertical height of each crest 254 above the floor 250 of a corresponding trough 248. Each sidewall 252 extends from the floor 250 to a corresponding crest 254 at an acute angle 256 to the base 212 of the vessel 200. In some embodiments which may be combined with other embodiments, it is contemplated that the acute angle 256 may be selected according to the angle of repose of the material to be handled in the vessel. For example, the acute angle 256 may be selected to be at least as large as the angle of repose of the material to be handled in the vessel 200. In one example in which it is contemplated that the vessel 200 is to be used to handle damp particulate material on one occasion and dry particulate material on another occasion, the acute angle 256 of each sidewall 252 may be selected to be at least as large as the maximum angle of repose of the damp particulate material and the dry particulate material. As an illustration in which the particulate material is sand, typical angles of repose are about 30-35 degrees for dry sand and about 40-45 degrees for damp sand; the acute angle 256 of each sidewall may be selected to be at least 45 degrees.

Each discharge conveyor 244 moves particulate material in each corresponding trough 248 towards a corresponding discharge point 260 from each trough 248, and ejects particulate material from the vessel 200 through a corresponding discharge valve 258, such as a gate valve. As shown in the figures, each discharge valve 258 is located a corresponding discharge point 260 at the first side 204 of the vessel 200. In some embodiments which may be combined with other embodiments, it is contemplated that some discharge points 260 and some discharge valves 258 may be located at the first side 204 and some discharge points 260 and some discharge valves 258 may be located at the second side 206 of the vessel 200. For example, if each discharge valve 258 is numbered in sequence from one end 208/210 to the other end 210/208, each odd-numbered discharge valve 258 may be located at the first side 204, and each even-numbered discharge valve 258 may be located at the second side 206 of the vessel 200.

In some embodiments which may be combined with other embodiments, it is contemplated that operation of each discharge valve 258 and/or each corresponding discharge conveyor 244 may be regulated in order to adjust an overall output of particulate material from the vessel 200. For example, most of the discharge valves 258 may be opened and most of the discharge conveyors 244 may be operated to achieve a relatively high output, whereas fewer discharge valves 258 may be opened and fewer discharge conveyors 244 may be operated to achieve a relatively low output. Additionally, or alternatively, a speed of operation of each discharge conveyor 244 may be regulated in order to adjust an overall output of particulate material from the vessel 200.

In some embodiments which may be combined with other embodiments, it is contemplated that one or more discharge valves 258 may be opened to allow particulate material to free-flow out of the vessel 200 without the aid of the corresponding discharge conveyor(s) 244. In an example, one or more discharge conveyors 244 may be omitted such that there is no corresponding discharge conveyor 244 associated with a selected trough 248 and the corresponding discharge valve 258. In another example, more than one discharge valve 258, such as two discharge valves 258, may be associated with a selected trough 248, and a discharge conveyor 244 may be located in the trough 248, but associated with only one of the discharge valves 258. In such an example, particulate material may free-flow from the trough 248 out of the vessel 200 through the discharge valve 258 that is not associated with the discharge conveyor 244, and may flow from the trough 248 out of the vessel 200 through a discharge valve 258 that is associated with the discharge conveyor 244 under free-flow and/or with the aid of the discharge conveyor 244.

As shown in FIG. 2B, particulate material exits the vessel 200 through each discharge valve 258 to an outflow conveyor 270. The particulate material passes through a chute 260. The chute 260 serves to mitigate spillage of particulate material and the release of dust into the surroundings. As shown in FIG. 2A, each discharge valve 258 is associated with a corresponding chute 260. Note that in FIG. 2C, the chutes 260 have been omitted. In some embodiments which may be combined with other embodiments, it is contemplated that more than one discharge valve 258 may be associated with a single chute 260. For example, two, three, four, or more discharge valves 258 may be associated with a single chute 260. Either or both of the first outflow conveyor 170 and the second outflow conveyor 180 may be configured in a same or similar way as the outflow conveyor 270. The outflow conveyor 270 may be any suitable type of conveyor, such as a belt conveyor, pocket belt conveyor, bucket elevator, screw conveyor, pneumatic conveyor, or a tubular drag disc conveyor.

A baffle 272 serves to provide a degree of uniformity of the flowrate of particulate material proceeding along the outflow conveyor 270. In some embodiments which may be combined with other embodiments, it is contemplated that the baffle 272 is attached to, or is part of, the outflow conveyor 270. Alternatively, the baffle 272 may be attached to, or be part of, a chute 260. In some embodiments which may be combined with other embodiments, it is contemplated that plurality of baffles 272 may be located along the outflow conveyor 270. In an example, a baffle 272 may be located downstream of the discharge from a corresponding chute 260, and there may be provided a baffle 272 corresponding to each chute 260. In other examples, a baffle 272 may be located downstream of every other chute 260, or every second chute 260, or every third chute 260, or every fourth chute 260, and so forth. Additionally, each baffle 272 may be adjustable such that a depth of particulate material on the outflow conveyor 270 may be regulated. In one example, each baffle 272 may be adjustable such that a depth of particulate material on the outflow conveyor 270 may be relatively shallow in an upstream portion of the outflow conveyor 270, and may be relatively deep in a downstream portion of the outflow conveyor 270. In other embodiments, it is contemplated that the baffle(s) 272 may be omitted.

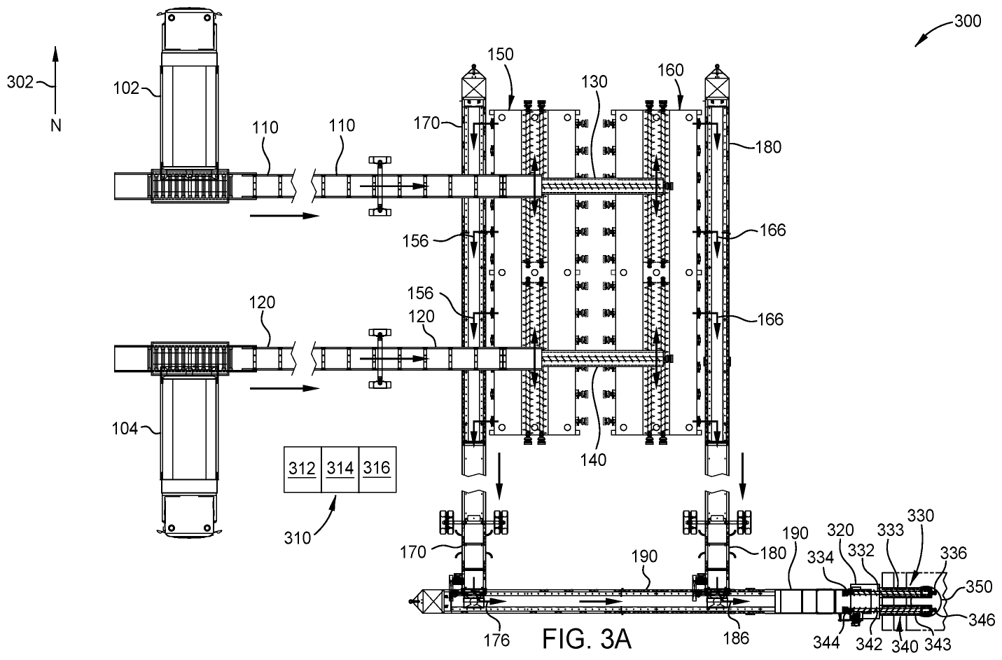

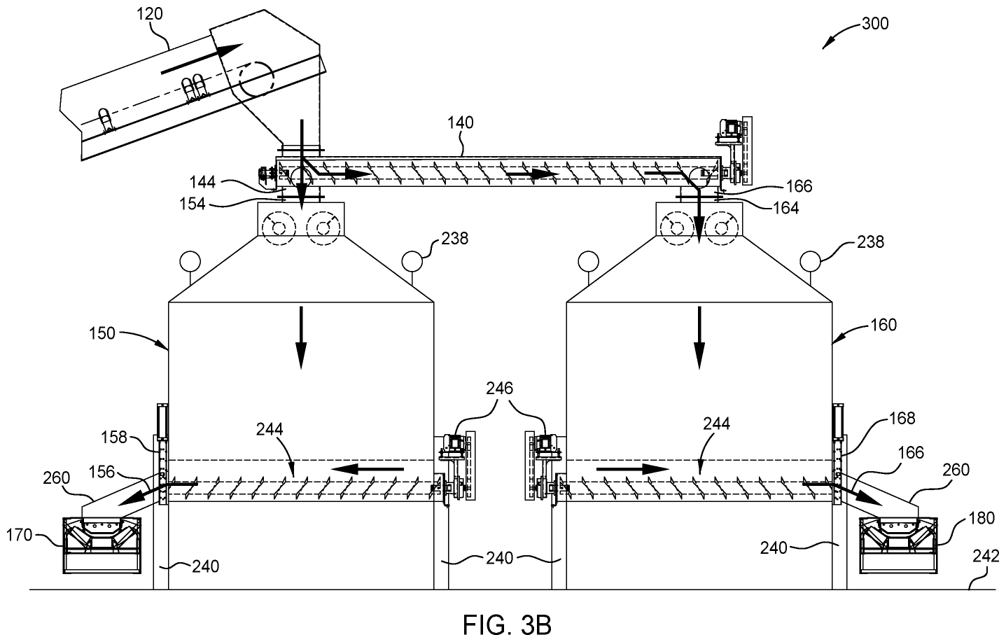

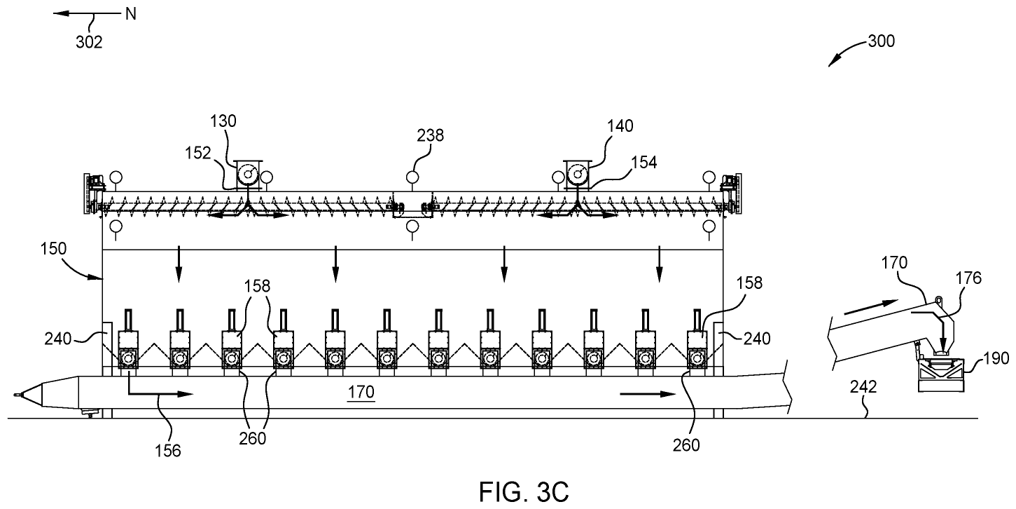

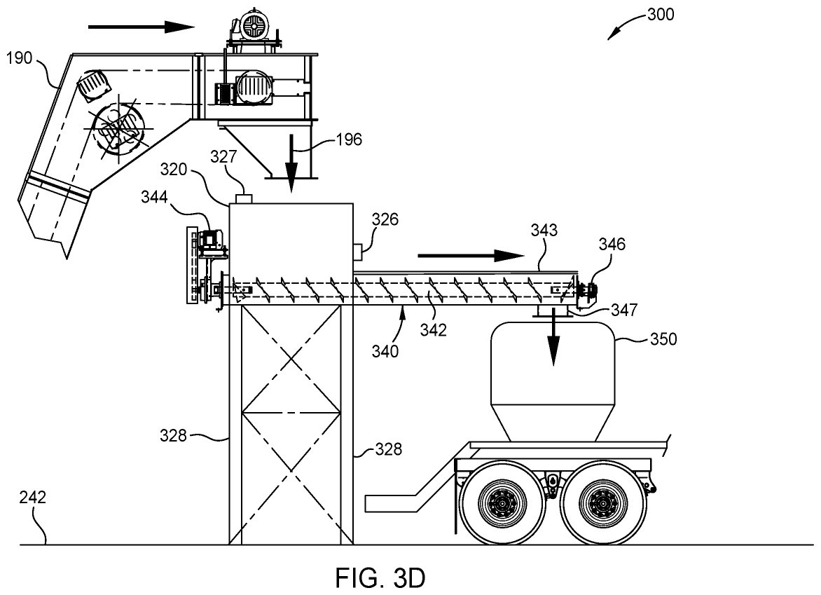

FIGS. 3A-3D provide views of a system 300 arranged to handle particulate material according to the process 100, and therefore FIGS. 3A-3D use the same reference numerals as used in FIGS. 1A-1C. The system 300 can be used in various industries, such as mining; construction; waste processing and recycling; food processing and distribution; minerals extraction and processing; and oil and gas. Arrows in FIGS. 3A-3D indicate the passage of the particulate material from upstream to downstream stages. FIGS. 3A and 3C include a reference direction 302 referred to as “north 302” for the purpose of describing relative orientations of components of system 300, it being understood that north 302 may represent any geographical or compass direction. FIG. 3A is a top view of the system 300. FIG. 3C is a view looking “east” with respect to north 302 of a portion of the system 300. FIGS. 3B and 3D provide views facing north 302 of portions of the system 300.

The first feed conveyor 110 is positioned generally east-west with respect to north 302. The first feed conveyor 110 is positioned adjacent, and generally parallel to, the second feed conveyor 120. The first feed conveyor 110 discharges the particulate material into the inlet 132 of the first transfer conveyor 130. As described above, the particulate material is distributed between the first 134 and second 136 outlets of the first transfer conveyor 130. The second feed conveyor 120 discharges the particulate material into the inlet 142 of the second transfer conveyor 140. As described above, the particulate material is distributed between the first 144 and second 146 outlets of the second transfer conveyor 140.

Particulate material exiting through the first outlet 134 of the first transfer conveyor 130 passes through the first inlet 152 of the first vessel 150. Particulate material exiting through the first outlet 144 of the second transfer conveyor 140 passes through the second inlet 154 of the first vessel 150. Particulate material exiting through the second outlet 136 of the first transfer conveyor 130 passes through the first inlet 162 of the second vessel 160. Particulate material exiting through the second outlet 146 of the second transfer conveyor 140 passes through the second inlet 164 of the second vessel 160. Note that while valves 137 and 147 are omitted from FIGS. 3A-3D, in some embodiments which may be combined with other embodiments, one or both valves 137 and 147 may be included. Additionally, the first 110 and second 120 feed conveyors have been omitted from FIG. 3C for clarity.

The first transfer conveyor 130 and the second transfer conveyor 140 are positioned generally parallel to each other and generally parallel to the first 110 and second 120 feed conveyors. The first vessel 150 is positioned adjacent the second vessel 160 such that the first vessel 150 is closer to the first 110 and second 120 feed conveyors than the second vessel 160. The first vessel 150 is orientated generally parallel to the second vessel 160. Additionally, the first vessel 150 and the second vessel 160 are generally perpendicular to the first 130 and second 140 transfer conveyors, and therefore are positioned generally north-south with respect to north 302.

Particulate material is discharged from the first vessel 150 to the first outflow conveyor 170 in one or more exit streams 156 as described above with respect to FIGS. 1A-2C. Particulate material is discharged from the second vessel 160 to the second outflow conveyor 180 in one or more exit streams 166 as described above with respect to FIGS. 1A-2C. Note that chutes 260 are depicted in FIGS. 3B and 3C, but are omitted from FIG. 3A. The first outflow conveyor 170 is positioned generally parallel to the first vessel 150, and the second outflow conveyor 180 is positioned generally parallel to the second vessel 160, and therefore the first 170 and the second 180 outflow conveyors are positioned generally north-south with respect to north 302. The first 150 and second 160 vessels are positioned between the first 170 and second 180 outflow conveyors.

The first 170 and second 180 outflow conveyors discharge particulate material to the transport conveyor 190 in streams 176 and 186, respectively. The transport conveyor 190 is positioned generally perpendicular to the first 170 and second 180 outflow conveyors, and therefore is positioned generally east-west with respect to north 302. In some embodiments which may be combined with other embodiments, it is contemplated that the transport conveyor 190 may include one or more baffles 272 as described in connection with the outflow conveyor 270 of FIG. 2B. In one example, at least one baffle 272 is positioned downstream of the discharge 176 of the first outflow conveyor 170, and at least one baffle 272 is positioned downstream of the discharge 186 of the second outflow conveyor 180. The one or more baffles 272 serve to provide a degree of uniformity of the flowrate of particulate material proceeding along the transport conveyor 190. Each baffle 272 may be adjustable such that a depth of particulate material on the transport conveyor 190 may be regulated. In one example, each baffle 272 may be adjustable such that a depth of particulate material on the transport conveyor 190 may be relatively shallow in a portion between the discharge 176 of the first outflow conveyor 170 and the discharge 186 of the second outflow conveyor 180, and may be relatively deep in a portion downstream of the discharge 186 of the second outflow conveyor 180. Alternatively, the baffle(s) 272 may be omitted.

The discharge 196 of particulate material from the transport conveyor 190 enters the hopper 320. FIG. 3A illustrates the screw 332 of the first infeed conveyor 330 extends from within the hopper 320 into the casing 333 of the first infeed conveyor 330. Additionally, the screw 342 of the second infeed conveyor 340 extends from within the hopper 320 into the casing 343 of the second infeed conveyor 340. However, alternatively, it is contemplated that the first 330 and second 340 infeed conveyors extend below an outlet of the hopper 320, such that the screws 332, 342 do not extend within the hopper 320.

As illustrated in FIG. 3D, the first 330 and second 340 infeed conveyors extend horizontally from the hopper 320 to the blender 350. In some embodiments which may be combined with other embodiments, it is contemplated that the first 330 and second 340 infeed conveyors may extend at an angle of up to fifty degrees, such as up to forty degrees, up to thirty degrees, up to twenty degrees, or up to ten degrees, with respect to horizontal. Additionally, it is contemplated that the first 330 and second 340 infeed conveyors extend downwardly from the hopper 320 at an acute angle with respect to horizontal.

The hopper 320 includes legs 328. As shown in FIG. 3D, the legs 328 stand on the ground surface 242, and maintain the hopper 320 in a position raised above the ground surface 242. In some embodiments which may be combined with other embodiments, it is contemplated that a length and/or a position of each leg 328 may not be adjustable. In some embodiments which may be combined with other embodiments, it is contemplated that a length and/or a position of each leg 328 may be adjustable, such as manually, mechanically, electrically, pneumatically, or hydraulically. In an example, the adjustable length and/or position of each leg 328 enables the hopper 320 to be positioned at a desired elevation above the ground surface 242. In another example, the adjustable length and/or position of each leg 328 enables the first 330 and second 340 infeed conveyors to be positioned at a desired orientation with respect to a horizontal plane, such as parallel to, or within about five degrees of, or within about ten degrees of, or within about twenty degrees of, a horizontal plane. In a further example, the adjustable length and/or position of each leg 328 enables the first 330 and second 340 infeed conveyors to be positioned at a desired orientation with respect to a horizontal plane even if the ground surface 242 is uneven or is inclined at a different orientation to the desired orientation.

It is further contemplated that each leg 328 may include a sensor that provides a signal representative of the weight being borne the corresponding leg 328. The signals from the sensor of each leg 328 may facilitate an estimation of the weight and/or distribution of the particulate material within the hopper 320.

In some embodiments which may be combined with other embodiments, it is contemplated that each leg 328 may be formed as part of the hopper 320. Additionally, or alternatively, each leg 328 may be attached to the hopper 320. Additionally, or alternatively, each leg 328 may be attached to a frame, and the frame may carry the hopper 320.

In some embodiments which may be combined with other embodiments, it is contemplated that a level indicator 327, such as an ultrasonic sonde, may provide a measurement of the level of particulate material within the hopper 320. In some embodiments which may be combined with other embodiments, it is contemplated that a vibration device 326 may be attached to the hopper 320. The vibration device may hinder a tendency of the particulate material to cluster and/or form bridges that adversely affects the flow of the particulate material into the first 330 and second 340 infeed conveyors.

The components of system 300 are modular and may be arranged in a variety of configurations. For example, the first 150 and second 160 vessels may be positioned east-west with respect to north 302 instead of north-south with respect to north 302, while the first 110 and second 120 feed conveyors remain positioned east-west with respect to north 302. In such an arrangement, particulate material exiting through the first outlet 134 of the first transfer conveyor 130 passes through the first inlet 162 of the second vessel 160. Particulate material exiting through the first outlet 144 of the second transfer conveyor 140 passes through the first inlet 152 of the first vessel 150. Particulate material exiting through the second outlet 136 of the first transfer conveyor 130 passes through the second inlet 164 of the second vessel 160. Particulate material exiting through the second outlet 146 of the second transfer conveyor 140 passes through the second inlet 154 of the first vessel 150. Continuing with the example, the first 170 and second 180 outflow conveyors would be positioned east-west with respect to north 302 instead of north-south with respect to north 302, and the transport conveyor 190 would be positioned north-south with respect to north 302. Other arrangements facilitated by the modularity of the components of system 300 are also contemplated.

In some embodiments which may be combined with other embodiments, it is contemplated that the system 300 may be augmented with additional components. For example, the system 300 may include one or more additional feed conveyors 110/120, one or more additional transfer conveyors 130/140, one or more additional vessels 150/160, one or more additional outflow conveyors 170/180, and/or one or more additional transport conveyors 190.

FIG. 3A also shows a power and control center 310. In some embodiments which may be combined with other embodiments, it is contemplated that the power and control center 310 may include a trailer that is furnished with equipment configured to control and provide power to at least some of the components of the system 300. Alternatively, or additionally, the power and control center 310 may include one or more free-standing units that may be loaded onto a trailer for transportation. The power and control center 310 includes a generation module 312 in which one or more generators generate electrical power. The power and control center 310 includes a connection module 314 from which power cables and/or data cables and/or control cables are routed to the components of the system 300. The power and control center 310 includes a control module 316 in which an operator monitors and controls the operation of the system 300.

The operator can monitor operation of the system 300 using data received from any of the level indicators 238, 327; data received from any of the scales 112, 122, 172, 182, 192; data associated with weight measurements of any of legs 240, 328; the current draw of any of the motors powering the conveyors, such as motors 131, 141, 236, 246; data received from any of the sensors associated with any of the conveyors 110, 120, 130, 140, 170, 180, 190, 270, 330, 340 (such as data received from sensor 336 or sensor 346); and/or the position of any of the valves 137, 147, 158, 168. Additionally, or alternatively, the operator can monitor operation of the system 300 using visual displays connected to one or more camera.

The operator can control the distribution of particulate material between the first 150 and second 160 vessels by controlling any one or more of the speed of the first feed conveyor 110, the speed of the second feed conveyor 120, the degree to which valve 137 is open, the degree to which valve 147 is open, the speed of the first transfer conveyor 130, the speed of the second transfer conveyor 140, the leveling mechanisms 218, 220 of the first 150 and second 160 vessels, or the rate of discharge from the first 150 and/or second 160 vessels.

The operator can control the rate of discharge from the transport conveyor 190 by controlling any one or more of the speed of the transport conveyor 190, the positioning of baffle(s) 272 on the transport conveyor, the speed of the first outflow conveyor 170, the positioning of baffle(s) 272 on the first outflow conveyor 170, the speed of the second outflow conveyor 180, the positioning of baffle(s) 272 on the second outflow conveyor 180, the degree to which each discharge valve 158, 168 of the first 150 and second 160 vessels is open, or the speed of each outflow conveyor 170, 180 of the corresponding first 150 and second 160 vessels.

Furthermore, the operator can control the rate of discharge into the blender 350 by controlling any one or more of the rate of discharge from the transport conveyor 190 into the hopper 320, the number of infeed conveyors 330/340 being operated, and the speed of operation of each infeed conveyor 330, 340.

At each stage of the process 100, the system 300 provides for appropriate levels of control of the handling and delivery of particulate material to subsequent stages, through to delivery of the particulate material to an endpoint, such as blender 350. For example, an upstream stage, such as receipt of particulate material from a truck 102/104 and delivery to a buffer volume, such as vessels 150, 160, may require only a relatively coarse control of the distribution of the particulate material between the first 150 and second 160 vessels. A midstream stage, such as the discharge of particulate material from the first vessel 150 may require a finer degree of control than that for the upstream stage described above. A downstream stage, such as delivery of the particulate material to an endpoint, such as blender 350, may require a close tolerance level of control that is finer than that for the midstream stage described above.

Embodiments of the present disclosure provide systems and processes for handling large quantities of particulate materials while facilitating the delivery of a consistent and controlled rate of feed of the particulate material to an end point, such as a blender.

While the foregoing is directed to embodiments of the present disclosure, other and further embodiments of the disclosure may be devised without departing from the basic scope thereof, and the scope thereof is determined by the claims that follow.

What is claimed is:

1. A vessel for handling particulate material, the vessel comprising:
opposing first and second sides;
opposing first and second ends, each end coupled to each side;
a base;
a first trough at the base, the first trough including:
a first floor; and
first and second sidewalls extending upwards from the first floor at a first acute angle to the base;
a first conveyor in the first trough, the first conveyor configured to move particulate material in the first trough towards a first discharge point at the first side; and
a first valve at the first discharge point.

2. The vessel of claim 1, wherein the first valve is a gate valve.

3. The vessel of claim 1, wherein the first conveyor is selected from a group consisting of a belt conveyor, a screw conveyor, a pneumatic conveyor, and a tubular drag disc conveyor.

4. The vessel of claim 1, further comprising:
a second trough at the base, the second trough including:
a second floor; and
third and fourth sidewalls extending upwards from the second floor at a second acute angle to the base;
a second discharge point; and
a second valve at the second discharge point.

5. The vessel of claim 4, wherein the second discharge point is at the first side.

6. The vessel of claim 4, wherein the second discharge point is at the second side.

7. The vessel of claim 4, further comprising a second conveyor in the second trough, the second conveyor configured to move particulate material in the second trough towards the second discharge point.

8. The vessel of claim 7, wherein the second conveyor is selected from a group consisting of a belt conveyor, a screw conveyor, a pneumatic conveyor, and a tubular drag disc conveyor.

9. The vessel of claim 1, wherein in use, the base is maintained in a raised position above a ground surface by a plurality of legs.

10. The vessel of claim 9, wherein the legs are adjustable to modify a height of the base above the ground surface.

11. The vessel of claim 10, wherein:
the legs are attached to a frame; and
the frame is attached to the base.

12. The vessel of claim 1, further comprising:
a roof coupled to the first and second sides and to the first and second ends; and
a first inlet in the roof, the first inlet configured for receipt of particulate material into the vessel.

13. The vessel of claim 12, further comprising a first leveling mechanism below the first inlet.

14. The vessel of claim 13, wherein the first leveling mechanism includes a conveyor configured to move particulate material towards the first end.

15. The vessel of claim 14, further comprising:
a second inlet in the roof, the second inlet configured for receipt of particulate material into the vessel; and
a second leveling mechanism below the second inlet;
wherein the second leveling mechanism includes a conveyor configured to move particulate material towards the second end.

16. A system for handling particulate material, the system comprising:
a first vessel including:
a first inlet configured for receipt of particulate material into the first vessel; and
a plurality of first discharge conveyors, each first discharge conveyor configured to move particulate material in the first vessel towards a corresponding first discharge valve; and
a first outflow conveyor configured to receive particulate material from each first discharge valve.

17. The system of claim 16, further comprising:
a second vessel including:
a second inlet configured for receipt of particulate material into the second vessel; and
a plurality of second discharge conveyors, each second discharge conveyor configured to move particulate material in the second vessel towards a corresponding second discharge valve; and
a second outflow conveyor configured to receive particulate material from each second discharge valve.

18. The system of claim 17, further comprising:
a transfer conveyor including:
a feed inlet configured for receipt of particulate material;
a first outlet coupled to the first inlet of the first vessel;
a second outlet coupled to the second inlet of the second vessel; and
a feed conveyor configured to discharge particulate material into the feed inlet;
wherein the transfer conveyor is selected from a group consisting of a belt conveyor, a screw conveyor, a pneumatic conveyor, and a tubular drag disc conveyor.

19. The system of claim 18, further comprising an inlet valve coupled between the first outlet of the transfer conveyor and the first inlet of the first vessel.

20. The system of claim 17, further comprising:
a transport conveyor arranged to receive a first discharge of particulate material from the first outflow conveyor and a second discharge of particulate material from the second outflow conveyor.
